(19) United States
(12) Patent Application Publication
(10) Pub. No.: US 2009/0203809 A1
(43) Pub. Date: Aug. 13, 2009

(54) NOVEL POLYURETHANES WITH A HIGH WATER CONTENT, METHOD FOR THE PRODUCTION AND APPLICATION THEREOF

(76) Inventors: Renate Marquardt, Bergkamen (DE); Frauke Petry, Göttingen (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/438,799

(22) PCT Filed: Aug. 24, 2007
(86) PCT No.: PCT/EP2007/007454

§ 371 Date: Feb. 25, 2009

(30) Foreign Application Priority Data
Aug. 25, 2006 (DE) 10 2006 039 901.3

(51) Int. Cl. C08J 9/00; C09K 3/00; C08F 2/32

(52) U.S. Cl. 521/67; 252/182.13; 524/801

(57) ABSTRACT

The subject of the invention is polyurethane materials with a high water content and with an elastomeric or cellular character for wide application fields and also a method for the production thereof.

The subject of the invention is polyurethane materials with a high water content and with an elastomeric or cellular character for wide application fields and also a method for the production thereof.

Polyurethane formulations normally contain absolutely no water or only stoichiometric water proportions because of the unfavourable equivalence relationship to the isocyanates, i.e. at most 1% by weight in the case of elastomer formulations, and at most 3% by weight in the case of water-driven foams.

Thus for example according to U.S. Pat. No. 4,683,929 and U.S. Pat. No. 4,416,844, compact bubble-free polyurethane tyre filling materials are produced from the normal polyurethane feedstocks, such as polyether polyols, aromatic diisocyanates and chain extenders and also oil-containing fillers, in the presence of a catalyst when using up to 0.6% by weight water relative to the total mass of component A, the carbon dioxide produced as a by-product being dissolved, on the one hand, in the oil-filled polyurethane and, on the other hand, being converted into inorganic carbonates.

According to DE 40 38 996, at most 1% by weight water, relative to the total mass of component A, is used specifically in order to form hard segments in oil-filled, cavity-free tyre filling materials. The carbon dioxide which is thereby produced as a by-product is distributed so finely in the elastomer material with the help of a special processing technology that no gas bubbles are visible to the naked eye.

Polyurethane formulations with a high water content contain in contrast super-equivalent quantities of water, which initially appears to be a contradiction with respect to the polyurethane stoichiometry. In fact, the use of super-equivalent quantities of water is only possible if it is possible to mask the water latently and, in this way, to withdraw it at times from the reaction with the isocyanate of component B and to supply it to the latter subsequently only in a small part which is required stoichiometrically.

The use of super-proportional quantities of water, relative to the isocyanate used, has been investigated and practised already many times with different methods, the aim predominantly residing in the formation of polyurea structures or foam structures comprising inorganic material.

Thus water bonded to water glass is converted, according to DE 29 08 746 C2, with isocyanate to form polyureas which can serve as rigid backfilling materials for mining. According to EP 0 151 937 B1 and DE 35 26 185 A1, foam waste or peat and coal materials are processed with polyureas to form clarification materials for effluents. According to U.S. Pat. No. 3,812,619 A, polyurea foams are produced as growing substrate with integrated seeds and fertilisers for horticulture.

Super-equivalent quantities of water are also applied according to DE 23 19 706 C2 but with a different objective and effect than is the case in the present invention. In this case, the water serves almost exclusively as carbon dioxide source in order to be able to inflate the additionally used, super-proportionally high quantities of solids to form a foam structure. The target product is therefore a foamed inorganic material rather than a polymer and the resulting polymer matrix therefore contains hardly any included water.

Analogously, DE 27 01 004 A1 describes the use of super-proportional quantities of water in order to be able to introduce high proportions of solids into a foam structure. As in the case of the document DE 23 19 706 C2, the water here likewise serves as expanding agent for producing carbon dioxide and not as an integrated component of the polymer matrix. The fire-resistance stressed in this document can be attributed to a combination of inorganic solids with the classic flame-retardants which contain chlorine and/or phosphorus but not to the effect of the incorporated water.

In DE 33 31 630, a vehicle tyre which is safer relative to gas loss is described, said tyre containing a compact polyurethane filling material with a high water proportion. However the method for the production thereof has significant defects as a result of the physical conditions being taken into account inadequately so that the reproducibility of the polyurethane reaction between the water-containing component A and the organic component B is not guaranteed.

According to DE 196 01 058, a compact polyurethane material with a high water content for the special application of tyre filling materials is obtained using organic swelling agents in component A and by specific use of rheological conformities. In this way, homogeneous, extensively durable A components are produced, which comprise up to 96% by weight of water and can react with conventional B components to form the desired compact polyurethane elastomers.

The compact polyurethane elastomers obtained according to DE 196 01 058 are intended exclusively for the special purpose of use as tyre filling materials and therefore are adapted to this application exclusively both in their composition with respect to production technology and end properties and also are suitable only for this purpose. Therefore polyurethane materials with a high water content are subjected outside the protective tyre cover to a shrinking process in that the water incorporated in the polymer matrix diffuses partially into the atmosphere until achieving a state of equilibrium. For the application purpose of the tyre filling material, this disadvantageous property is irrelevant since the tyre cover represents a safe diffusion barrier. However the shrinkage of a water-containing polyurethane body is not acceptable for other application purposes.

It is the object of the present invention to overcome the deficiencies associated with the state of the art and the serviceability restriction for polyurethane materials with a high water content and to present novel formulations with high water contents and variable, ecologically valuable properties which can be produced according to a simplified, industrially practicable method.

According to a first aspect, the invention relates to a compact or cellular polyurethane with a high water content, obtainable by reaction of a component A and a component B, optionally in the presence of an expanding agent, component A comprising water in a proportion of at least 50% by weight, an organic swelling agent, an agent for preventing shrinkage and optionally further organic or inorganic additives, and component B comprising one or more polyhydroxy compounds, one or more polyisocyanates and/or the reaction product thereof, optionally a plasticiser and further organic or inorganic additives.

According to a further aspect, the invention relates to a cellular polyurethane with a high water content, obtainable by reaction of a component A and a component B, optionally in the presence of a expanding agent, component A comprising water in a proportion of at least 50% by weight, an organic swelling agent, optionally an agent for preventing shrinkage and optionally further organic or inorganic additives, and component B comprising one or more polyhydroxy compounds, one or more polyisocyanates and/or the reaction product thereof, optionally a plasticiser and further organic or inorganic additives.

Conventional cellular polyurethane formulations can be produced, as long as no hydrocarbons or halogenated hydrocarbons are used as expanding agent, by the addition of equivalent quantities of water, e.g. 1 to 10% by weight, relative to the mass of the isocyanate-reactive component from which the quantities of carbon dioxide required for the inflation are produced during the reaction with the isocyanate, see e.g. EP-B-0 689 561. The cellular polyurethane formulations according to the invention preferably differ therefrom by the use of super-equivalent quantities of water, of which however respectively only a small proportion is used for the carbon dioxide formation whilst the predominant remainder is masked latently by the use of swelling agents and therefore does not take part in the polyurethane reaction. The cellular polyurethane formulations according to the invention can be open-cell or closed-cell.

According to yet a further aspect, the invention relates to a compact or cellular polyurethane with a high water content, obtainable by reaction of a component A and a component B, optionally in the presence of an expanding agent, component A comprising water in a proportion of at least 50% by weight, an organic swelling agent, selected from polymers on an acrylic basis, optionally an agent for preventing shrinkage and optionally further organic or inorganic additives, and component B comprising one or more polyhydroxy compounds, one or more polyisocyanates and/or the reaction product thereof, optionally a plasticiser and further organic or inorganic additives.

According to yet a further aspect, the invention relates to a compact or cellular polyurethane with a high water content, obtainable by reaction of a component A and a component B, optionally in the presence of an expanding agent, component A comprising water in a proportion of at least 50% by weight, an organic swelling agent, optionally an agent for preventing shrinkage and optionally further organic or inorganic additives, and component B comprising one or more polyhydroxy compounds, one or more polyisocyanates and/or the reaction product thereof, optionally a plasticiser and further organic or inorganic additives, the plasticiser predominantly comprising products based on renewable raw materials.

In addition, the invention relates to a polyurethane composite material, comprising a polyurethane with a high water content, in particular as described before, in conjunction with an substantially water-free polyurethane.

The compact or cellular polyurethanes with a high water content according to the invention are preferably distinguished in that they are non-flammable. The polyurethanes according to the invention are preferably substantially free of halogen- and/or phosphorus-containing flame-retardants, i.e. such supplements are present at most in a proportion of up to 0.1% by weight, based on the total mass. The polyurethanes according to the invention are particularly preferably free of these supplements.

The mass of non-reacted water in the polyurethanes with a high water content according to the invention is preferably from 25 to 49% by weight, particularly preferred from 40 to 48% by weight, based on the total mass.

The polyurethanes with a high water content according to the invention or these composite materials comprising polyurethanes with a high water content are suitable for all applications in which polyurethanes are used, in particular for fire-protection applications, insulating jackets in the construction industry, as insulating layers e.g. in wagon building, ship building and domestic refrigerator construction, for automotive vehicle trims, for fire-sensitive areas, such as mining, for cavity filling, as coating material for fire-risk building and machine parts, as resilient pads in ships fenders, for sound and heat insulation for fields with particular ecological requirements, for the production of orthopaedic moulded articles, as sealing material in water, effluent and sanitation technology.

The polyurethanes or polyurethane composite materials according to the invention can be obtained by a method comprising the reaction of a component A and of a component B, optionally in the presence of an expanding agent, component A comprising water in a proportion of at least 50% by weight, an organic swelling agent, optionally an agent for preventing shrinkage and optionally further organic or inorganic additives, and component B comprising one or more polyhydroxy compounds, one or more polyisocyanates and/or the reaction product thereof, optionally a plasticiser and further organic or inorganic additives, component A being produced optionally via the intermediate step of a concentrate with a reduced water proportion, component B being produced optionally via the intermediate step of a concentrate with a reduced plasticiser proportion, both components being reacted optionally in the presence of an expanding agent and the resulting end product with a high water content being converted into a composite material, optionally in addition with essentially water-free polyurethane.

The present invention begins with the knowledge that polyurethane materials with a high water content can be produced by a specific choice of reactands and by the use of novel swelling agents and additives for components A and B both with a compact and a cellular habit, including all transition regions between these embodiments, and also novel combination products with conventional polyurethanes according to simplified methods, end products with a high water content and improved processing properties, improved physical and mechanical characteristic values being able to be generated by this modus operandi and consequently numerous further fields of application being able to be opened up.

For this purpose, both the water-containing component A and the isocyanate component B respectively are varied specifically according to the desired application purpose and the processing and end properties associated therewith.

Component A used for the production of the polyurethanes with a high water content comprises water in a weight proportion of at least 50% by weight, preferably at least 60% by weight, particularly preferred at least 70% by weight, even more particularly preferred 80% by weight and most preferably at least 90% by weight on the basis of the total weight of component A. There can be used as water mains water, deionised water but also pit water from mining which normally contains acidic salts.

Furthermore, component A contains a swelling agent which is able to bind the water comprised in component A. The swelling agent is normally used in a proportion of 0.5 to 10% by weight, preferably of 1 to 5% by weight, particularly preferred of 1 to 3% by weight and most preferred of 1.4 to 2.6% by weight based on the total weight of component A. Examples of swelling agents are cellulose derivatives, in particular modified, e.g. hydroxylated cellulose derivatives, such as for instance hydroxypropoxylated cellulose derivatives, in particular differently modified cellulose derivatives of the company Dow Chemicals, such as hydroxyethyl cellulose, butyl glycidyl ether of cellulose, sodium-carboxymethyl cellulose, particularly preferred propoxylated cellulose derivatives, such as are obtained by conversion of natural cellulose with different propylene oxide quantities.

It was also established surprisingly that liquid-absorbable organic polymers or copolymers, in particular polymers or copolymers on an acrylic basis, e.g. on the basis of (meth)acrylamide, (meth)acrylic acid and/or (meth)acrylic esters, are suitable. Copolymers based on acrylamides and/or acrylic acid are preferred, such as are used for the production of disposable nappies (e.g. Stockosorb sorts by Degussa/Stockhausen). The use of acrylates as water binders has a positive effect on the shrinkage behaviour of the end product in that the tendency towards shrinkage can be reduced solely as a result to approx. 1% by weight or 1% by volume, relative to the initial mass and the initial volume, until achieving the end or equilibrium state.

There can be used as inorganic additives for the aqueous component A alkaline earth oxides or alkaline earth hydroxides, such as magnesium oxide, calcium hydroxide and barium hydroxide. These materials catalyse not only the polyurethane reaction because of their basicity but at the same time bind the one part of the carbon dioxide produced as by-product of the polyurethane reaction in the form of corresponding carbonates. The type and quantity of the alkaline earth oxides or alkaline earth hydroxides which are used thereby jointly decides on the habit of the polyurethane end product. If cellular end products are desired, the proportion of alkaline earth oxides or alkaline earth hydroxides must be higher than for compact, bubble-free polyurethane materials. For cellular products alkaline earth oxides or alkaline earth hydroxides are used in quantities of preferably 4 to 8% by weight, particularly preferred 5 to 7% by weight, based on the total mass of component A. For compact, bubble-free formulations, in contrast preferably at most 4% by weight, particularly preferred 1 to 2% by weight, based on the total mass of component A, are used.

There are used optionally as reaction retarders in addition alkaline earth salts, such as magnesium chloride or calcium chloride, in quantities of preferably 0.5 to 2.5% by weight, particularly preferred 1 to 2% by weight, based on the total mass of component A. Supplements of aluminium hydroxide in quantities of preferably 0.5 to 1.5% by weight, particularly preferred 0.75 to 1.25% by weight, based on the total mass of component A, in combination with the acrylate swelling agents used, produce a virtually shrinkage-free end product.

In addition, it has been shown that additives from the building industry and specific textile auxiliary materials likewise exert a positive effect on the tendency towards shrinkage of the polyurethane products with a high water content in that they counteract it. Different alkylsilanes and silicone resin emulsions, e.g. Protectosil 40 S and 100 and Tegosivin HE 899 and HL 1000 by Degussa, have proved to be advantageous. Aminosiloxane emulsions, such as e.g. Phobe 1401 and Phobe 1200 by Degussa, also in combination with hydroxylpropyl cellulose as swelling agent, are particularly effective against shrinkage. Alkylsilanes, silicone resin emulsions and aminosiloxane emulsions are added to component A in quantities of preferably 0.5 to 2.5% by weight, particularly preferred 1 to 2% by weight, based on the total mass of component A.

Further substances which prevent shrinkage are e.g. the purely inorganic calcium sulphoaluminates which are used in the construction industry for low-shrinkage mortars and dimensionally stable types of concrete and which are obtained by a special heat treatment from calcium oxide, aluminium oxide and calcium sulphate and, in supplements of preferably 0.5 to 2.5% by weight, particularly preferred 2% by weight, based on the total mass of component A, also significantly improve resistance to shrinkage in the polyurethane materials according to the invention.

Further preferred organic additives for component A are urea and urea derivatives, such as diphenylurea, and also various alkylenediamines, such as e.g. alkylenediamines of different masses of 400 to 3000 with terminal amino groups, as a result of which the hard segment proportion of the end product can be controlled. These organic additives are used in proportions of preferably 0.2 to 1.2% by weight, particularly preferred 0.5 to 0.7% by weight, based on the total mass of component A.

Furthermore, additives of some neutral soap, e.g. as sodium alkylsulphonate, in a proportion of preferably 0.1 to 0.3% by weight, particularly preferred 0.2% by weight, based on the total mass of component A, are advantageous for improving the flow behaviour.

The previously mentioned solid supplements, in particularly inorganic solid supplements, are preferably used only in small quantities, for example up to 2 or 3% by weight, at most 5% by weight, based on the reacted-out polyurethane.

The production of component A is effected preferably via the following steps at room temperature and normal pressure:
swelling of the thickener, e.g. of the modified cellulose or of the acrylates in at most 25% of the required total water quantity, until a viscosity range of 1200 to 2800 mPas, preferably 1600 to 1900 mPas, at 20° C. is achieved.
addition of the inorganic and organic components of component A mixed in a further 25% of the total water quantity as soon as the limiting viscosity of the first step is reached and subsequent intensive mixing of all the components.

In this way, a concentrate of component A is obtained, which can be topped-up by mixing in the still missing 50% of the total water quantity at any time and at any position in a suitable mixing container to form the ready-to-use component A. It has been shown that the production of the component A has advantages over the step of a concentrate with respect to both process control and economics. Thus for example the danger of the formation of phases as a result of precipitation of the inorganic components is almost completely precluded because the higher limiting viscosity of the concentrate counteracts sedimentation. The reduction in volume is in addition an advantage not to be underestimated with respect to storage and transport in that the water available for every end processor need not be transported unnecessarily over long distances. Of course should it be desired and required, the complete component A can however also be mixed ready-to-use by the producer.

A further subject of the invention is hence a concentrate of component A for the production of a compact or cellular polyurethane with a high water content, containing water in a proportion of at least 25 to 50% by weight, an organic swelling agent, an agent for preventing shrinkage and optionally further organic or inorganic additives.

There is used as water normal mains water with a pH value 6.8 to 7.2, it having been proved to be advantageous to operate at water temperatures of 12 to 25° C., preferably 18 to 21° C. The swelling rate of the cellulose is highly dependent upon the water temperature. In principle, it is possible to operate also at higher or lower temperatures than those indicated, however the reaction can be conducted best in the chosen temperature range without the result being an irreversible increase in viscosity, as in the case of higher temperature values, or delayed swelling as in the case of low temperature values.

Furthermore, it has been shown that water of another origin is also suitable within a limited scope for the production of component A. Thus tests with pit water from underground coal mining result in the swelling agents which are used, i.e. the modified cellulose types and the swellable acrylates, also being able to swell well in this often highly acidic water with pH values down to 3.8 if longer swelling times can be accepted or if the pH value is specifically increased by suitable supplements, e.g. alkaline or alkaline earth carbonates. The use of pit water, which is present in large quantities and which must be controlled according to a complicated system and conveyed to the surface, instead of mains water, offers completely new possibilities for the production and use of polyurethane materials with a high water content in that these can be produced underground and used for cavity filling, the excellent fire-resistance of the material being made full use of.

For component B, the polyisocyanates commonly used for polyurethane elastomers and polyurethane foams, in particular diisocyanates, such as toluoylene diisocyanates and 4,4-diphenylmethane diisocyanates, but also naphthylene diisocyanates and aliphatic diisocyanates, such as hexamethylene diisocyanate, can be used. There has proved to be particularly suitable the carbodiimide-modified derivatives of 4,4′-diphenylmethane diisocyanate which are available from producers in differently reactive embodiments, based on special mixtures of positional-isomeric derivatives. By using such reactivity-regulated types, the natural high reactivity of component A can be controlled very readily, which is of significance in particular for the production of compact bubble-free end products. However the reactivity can also be specifically influenced by supplements of isophorone diisocyanate.

Component B contains in addition one or more polyhydroxy compounds. These polyhydroxy compounds or polyols are preferably used in a stoichiometric deficit, e.g. in the stoichiometric deficit of 10 to 35%, preferably of 12 to 30% and particularly preferred of 15 to 27%, in order to produce a quasi-prepolymer and, in this way to preformulate the polymer matrix in which the aqueous component A is then embedded, partially reactively, because of the hydrogen-active supplements thereof, such as amines and ureas, partially inertly. Component B preferably has a total NCO content of at most 5%, particularly preferred of at most 3%, the total NCO content being produced from the NCO content of the isocyanate used, from the proportion (% by weight) of this used isocyanate in component B and from the partial use (% by weight) of this isocyanate by the polyol present in stoichiometric deficit.

The polyhydroxy compounds or polyols are organic compounds which have two or more, e.g. two or three, hydroxyl groups reactive relative to polyisocyanates, including polyester- and polyether alcohols. There are suitable as polyols preferably medium- and long-chain polyether alcohols with functionality values between 2 and 3, which are obtained on the basis of glycerol or trimethylol propane by anionic or cationic polymerisation of propylene oxide and/or ethylene oxide or tetrahydrofuran. The spectrum of polyether alcohols which are used extends thereby from polypropylene glycol with a molar mass of 400 up to long-chain polymers predominantly comprising propylene oxide and a little ethylene oxide with molar masses of 3500 to 6500. The appropriate types, Lupranol, Desmophen, Voranol, by the companies BASF, Bayer, Dow Chemicals, and comparable products by other producers are hereby suitable.

For the production of compact and cellular elastomers, the quasi-prepolymer is diluted, according to the desired degree of hardness, with different quantities of plasticisers or mixtures of different plasticisers. The plasticisers are used in a proportion of preferably 45 to 75% by weight, particularly preferred 52 to 68% by weight, based on the total mass of component B. The composition of the plasticiser mixtures respectively according to the desired degree of hardness, is thereby in the range of 5:23:40 to 5:25:35% by weight (completely synthetic plasticisers:aromatic mineral oil extracts:vegetable oil esters) for soft formulations in the range 5:20:40 to 5:25:35% by weight (completely synthetic plasticisers:vegetable oil esters:aromatic mineral oil extracts) for medium-soft formulations and in the range 5:15:35 to 5:5:45% by weight (vegetable oil esters:aromatic mineral oil extracts:completely synthetic plasticisers) for harder formulations. For supersoft formulations, pure vegetable oil esters or mixtures thereof are used. The replacement of vegetable oil esters by aromatic mineral oil extracts of 5 to 80% by weight, preferably 10 to 60% by weight, based on the total quantity of plasticisers, leads to a gradual increase in hardness from 1 to 6 Shore A.

On the one hand, process oils from crude oil refining can thereby predominantly be used as plasticisers. Process oils in this sense are thereby predominantly aromatic extracts which are present as a by-product in crude oil processing in alternating composition. Because of the content thereof of aromatic and polycyclic aromatics, these process oils are highly compatible within a limited scope with the remaining polyurethane feedstocks and therefore are suitable as plasticisers on a scale of conditionally to good. Since the oil-containing plasticisers can be introduced into the tyre filling systems as a function of their respective characteristic values in proportions up to 60% by weight, their use also had in addition an economical aspect because of the comparatively low price thereof to date.

The disadvantages of the oil-containing plasticisers reside in their varying quality, in the toxicity which is conditional upon the content of polycyclic aromatics accompanied by their certification requirement, in their disappearing availability because of structure refining in the refinery industry and in constantly increasing prices in the crude oil market which have the effect of increasing the price of all crude oil products.

The varying quality of the process oils is expressed in particular in changing contents of paraffinic, naphthenic and aromatic hydrocarbons and in different acid contents and is dependent upon the geographical origin of the crude oil and also upon the respectively practised processing method. On the part of the refinery industry there is no or only a low degree of interest in minimising these property variations by means of suitable subsequent treatments since the aromatic extracts are treated definitively as crude products and are accepted at this quality by the further-processing industry.

However stricter quality requirements apply to polyurethane chemistry. In order to obtain end products of constantly good quality, feedstocks with tightly specified characteristic values are required.

A particularly striking disadvantage of process oil plasticisers resides in the tendency thereof to be exudated from the polymer composite. This disadvantageous property is closely related to the aromatic content and in particular to the proportion of polycyclic aromatics. The higher the proportion of aromatics and polycyclic aromatics in the oil, i.e. of toxic compounds, the smaller is the exudation tendency. Conversely, the exudation tendency increases with increased proportions of paraffinic and naphthenic hydrocarbons. This means that a less toxic oil is less suited as plasticiser for polyurethane elastomers than a process oil of a higher toxicity. Process oils with aromatic contents of approx. 30% and proportions of polycyclic aromatics from 1%, as are best suited to exudate-free, soft polyurethane-elastomer systems, are subject in addition to the characterisation requirement according to the current European and national chemical regulations and therefore require special specifications for the storage and handling of these crude materials to be observed.

On the other hand, also fully synthetic plasticisers can be used. These products predominantly concern esters of phthalic acid, such as e.g. dioctyl phthalate, diethylhexyl phthalate, diisononyl phthalate, esters of aliphatic dicarboxylic acids, such as e.g. adipic dinonyl ester or also cyclodicarboxylic ester, such as esterification products from cylcohexanedicarboxylic acid with C₉ alcohol mixtures.

These synthetic plasticisers in fact have the advantage that they are available at a constant quality and, because of their steric property, only rarely tend or have no tendency to migrate out of the polymer composite, however they have an unfavourable effect, in comparison with most process oils, on the elastic characteristic values of the end product. Furthermore, risky physiological properties were indicated for esters of phthalic acid, in particular for diethylhexyl phthalate, so that these plasticisers are ruled out from the beginning for specific application fields, such as children's toys and decorative articles. In addition, synthetic plasticisers, in comparison with process oil plasticisers, are relatively expensive and do not therefore offer any economic inducement for use on a larger scale.

Expediently there are therefore used, according to the present invention, at least predominantly, i.e. more than 40% by weight, preferably more than 50% by weight, particularly preferred more than 75% by weight and particularly preferred more than 95% by weight, based on the total weight of the plasticisers, plasticisers from renewable raw materials. Such plasticisers from renewable raw materials are predominantly esterification products of natural oils or the natural oils themselves in a suitable form. The indigenous, European and non-European flora provides a wide spectrum of oleaginous plants which are grown increasingly agriculturally with the aim of obtaining raw materials and subsequently are exploited industrially. The indigenous oil plant which has been used most to date is rape. The rape-seed oil obtained therefrom has been used already for some time as starting material for so-called biodiesel in that it is converted by reesterification with methanol into a quality suitable for fuel.

Furthermore, numerous further oil plants have become of interest in the meantime as raw material sources for the chemical and for the mineral oil industry, such as sunflowers, soya plants, hemp, poppy, oil flax, cameline, olives, safflower, ricinus and different types of thistles and palms.

For the present purpose of use as plasticisers, there have proved to be suitable as plasticisers above all the esterification products of rape-seed oil, palm oil and ricinus oil, e.g. rape-seed oil methyl ester, palm oil methyl ester and ricinus oil methyl ester. Surprisingly, it was thereby shown that the conventional process oil plasticisers can be replaced entirely by reesterification products of rape-seed oil, palm oil and ricinus oil. These vegetable oil esters display very good compatibility with all other components of polyurethane systems, do not have a disadvantageous effect on the physical-mechanical properties of the polyurethane end products and do not have a tendency, contrary to expectation, to be exudated, which was to be feared initially because of the predominantly linear structure, the low density and low viscosity of these compounds. Instead the end products produced with them have completely smooth and dry surfaces which are maintained unaltered over a wide temperature range. In addition, the vegetable oil esters are miscible in any ratio with process oil- and synthetic plasticisers, which facilitates use of mixtures of different types of plasticisers.

Component B is produced by mixing the components in an agitated container or circulating mixer. For this purpose, the plasticiser is introduced, thereafter the polyol or polyol mixture is added, finally the isocyanate or isocyanate mixture is added. After a mixing time of preferably 1 to 2 hours, the B component is filled into drums. Before processing thereof, it should rest preferably for 8 to 24 hours, particularly preferred 12 to 20 hours, in order that the quasi-prepolymer can form as completely as possible.

Analogously to the production technology of component A, it is also possible for component B optionally to produce a concentrate in order to save transport and storage capacity. For this purpose, the mixture is prepared only with part of the calculated quantity of plasticiser, at most with 50% thereof. The remaining proportion of plasticiser is then mixed in shortly before the processing.

A further subject of the invention is hence a concentrate of component B, containing one or more polyhydroxy compounds, one or more polyisocyanates and/or the reaction product thereof, a plasticiser up to 50% of the total quantity of the quantity required for producing the polyurethane and optionally further organic or inorganic supplements.

For production of polyurethane materials with a high water content and with a compact and cellular habit, components A and B are mixed together intimately in a suitable weight or volume ratio in a mixing device and made to react, the mixing ratio for the production of foams with a high water content for A:B being also able to be 1:0.2 to 1:1, predominantly however 1:0.4 to 1:0.8.

In the production of cellular polyurethane materials, additional expanding agents can be used such as are normal in the field of the production of polyurethanes, for example hydrocarbons, such as for instance pentane or halogenated hydrocarbons, such as for instance fluorochlorinated or fluorinated hydrocarbons.

The production of cellular polyurethane materials is effected however preferably without the addition of conventional expanding agents, such as pentane or fluorochlorinated or fluorinated hydrocarbons. There are used preferably as expanding agents for the polyurethane materials according to the invention exclusively the carbon dioxide originating from the reaction of water and isocyanate, the quantity and the speed of the gas formation being influenced by the composition of components A and B.

All polyurethane materials according to the invention can be produced without addition of normal catalysts, such as organotin compounds or diazabicyclooctane (Dabco), since the basic components of component A, the alkaline earth compounds and also the amine-terminated polyether alcohols, catalyse the polyurethane reaction adequately. The greater the pH value of component A, the faster the polyurethane reaction commences and the shorter is the curing time.

Cellular polyurethane foams with a high water content according to the present invention are distinguished preferably by a volumetric density of 0.03 to 0.3 g/cm³, particularly preferably of 0.06 to 0.19 g/cm³. If necessary, foam stabilisers of the Tegostab® series are added to achieve a uniform porosity.

The shrink resistance of the polyurethane materials according to the invention is significantly better due to the defined metering of the described additives compared to the formulations according to DE 196 01 058. Whilst the formulations according to DE 196 01 058 have a weight loss of 9 to 11% within 30 days at room temperature and normal pressure due to the water vapour diffusion from the polymer, but do not shrink further thereafter, the weight constancy of the polyurethane materials according to the invention is ensured within narrow limits and is preferably ≦5% by weight, particularly preferred ≦1% by weight and most preferred 0.01 to 0.2% by weight after 30 days, relative to the total mass, after storing at room temperature and normal pressure.

For the dimensional stability or volume constancy, the corresponding values apply taking into account the volumetric density of the polyurethane material. Thus the analogous values apply in % by volume if the reacted-out material in the formulations has a specific weight of around 1.0 g/cm³, i.e. percentage by weight and percentage by volume are equal. Preferably the volume constancy is ≦5% by volume, particularly preferred ≦1% by volume and most preferred 0.01≦0.2 by volume.

The shrinkage behaviour is determined in the following manner. The cured material is sawn into cubic bodies of 5 cm edge length. Respectively 5 test bodies form one measurement series. Test bodies are stored at room temperature (20° C.) and normal pressure (respectively prevailing atmospheric pressure). At an interval of 48 hours, over a period of time of 30 days, weight and edge length are determined and therefrom the change in weight and volume is determined.

The polyurethane filling materials according to the invention, especially the compact formulations for special application purposes, e.g. for sealing and insulation materials, can be drawn very well with different fillers, as a result of which higher hardnesses and tensile strength values are achieved than with formulations free of fillers. Particularly well suited fillers are quartz powder, barite powder, microballoons, aluminium powder, sea sand and balsa wood powder. For this purpose, the fillers are distributed homogeneously in the still liquid reaction mixture in quantities of 5 to 70% by weight, preferably 15 to 60% by weight, relative to the total mass of components A+B and are incorporated in this way in the polymer matrix.

The polyurethane materials according to the invention are preferably flame-resistant or non-flammable, as determined by the subsequently described laboratory method:

Freely suspended test bodies of the dimensions 250×120×60 mm are flame-treated directly for 7 minutes at a temperature of 700 to 750° C., the time up to the first fire reaction and up to the flame dying out being measured. The following classification is arrived at: ignition after 2 minutes flame contact and uniform burning: flammable; ignition after 4 minutes flame contact and self-extinguishing after 1 minute burning duration: flame-resistant; no ignition: non-flammable.

It was shown furthermore that the reacted-out polyurethane materials with a high water content can be compounded within a period of time of preferably 1 to 12, particularly preferred 4 to 9 hours, after production thereof without further additives with conventional, essentially water-free polyurethane materials by applying reaction mixtures thereof comprising the respective components A and B in corresponding moulds or by free coating, as a result of which new high-quality polyurethane materials are produced for special application purposes, e.g. ships fenders, in which the excellent properties of both polyurethane embodiments, water-containing and water-free, can be combined ideally to form new applicational properties.

Furthermore, the invention is intended to be explained by the subsequent examples.

### EXAMPLES

### General Production Example for Compact Formulations

For the production of component A, firstly the thickening agent, i.e. the modified cellulose or the acrylate, are swollen in at most 25% of the required total water quantity with constant agitation until a viscosity range of 1,000 to 2,500 mPas, preferably 1,600 to 1,900 mPas, at 20° C. is reached. Thereafter, the inorganic and organic components of component A which are mixed in a further 25% of the total water quantity are supplied. The remaining 50% of the total water quantity are only added shortly before the polyurethane reaction with component B with vigorous agitation. Component B is produced by mixing all the components together, the isocyanate being added as last component. Before processing, component B must rest for at least 8 hours.

The polyurethane reaction is effected by mixing together components A and B in the volume or weight ratio 1:1 at room temperature and with subsequent short-term degassing at 20 to 60 mm Hg, preferably at 30 to 50 mm Hg, or by introducing the reaction mixture with a pump pressure of 2 to 30 bar, preferably 5 to 25 bar, into a closed mould, the mixture curing within 8 to 12 hours to form an elastic, bubble-free material.

### Embodiment 1

According to the method described under the general production example, 300 g component A and 300 g component B are produced, are reacted together after mixing in a further 100 g water to component A and thereafter the following properties are measured:

In the case of the following embodiments, the subsequently listed abbreviations are used:
MM: molar mass
PPET: polyether alcohol based on glycerine or trimethylolpropane, propylene oxide and ethylene oxide (polyoxypropylene ethylene triol), e.g. Lupranol 2040° or Democast 8901 Y®
EDA-polyol: polyether alcohol based on ethylene diamine and propylene oxide, e.g. Arcol 3420® or Arcol 3450®
4,4′-MDI: diphenylmethane diisocyanate, e.g. Lupranat MM 103® or Desmodur CD® or Suprasec 2020®
PPG 400: polyether alcohol based on ethylene glycol and propylene oxide, e.g. Vorano 1400® or Desmophen 4000Z®
PPG-diamine: amine-terminated polypropylene glycol, e.g. Jeffamine D 230® or Jeffamine D 400®

Component A

| | | |
|---|---|---|
| Hydroxypropyl cellulose, e.g. Methocel ® J75 MS | 5.60 | g |
| Water | 200.00 | g |
| Magnesium oxide | 4.00 | g |
| Calcium chloride | 1.00 | g |
| Water | 86.52 | g |
| EDA-polyol, MM 3000 | 2.00 | g |
| Na-alkylsulphonate e.g. Linda ® neutral | 0.80 | g |
| Methylpolysiloxane, e.g. Silicex ® 107 A | 0.08 | g |
| (Water) | (100.00 | g) |

| | |
|---|---|
| Viscosity at 20° C. (mPas), measured | 1940 |
| before dilution | |
| pH value | 9.9 |

Component B

| | | |
|---|---|---|
| PPET, MM 6000 | 84.00 | g |
| PPET, MM 3500 | 8.00 | g |
| Rape-seed oil methyl ester | 240.00 | g |
| Diisooctyl phthalate, e.g. Palatinol ® AH | 8.00 | g |
| Palm oil methyl ester | 20.00 | g |
| 4,4′-MDI, e.g. Lupranat ® MM 103 | 40.00 | g |

| | |
|---|---|
| Viscosity at 20° C. (mPas) | 650 |
| NCO content (%) | 2.8 |

Component A + B

| | at room temperature |
|---|---|
| Pot life (min) | 27 |
| Shore A hardness | 9-10 |
| Tensile strength (kN/m²) | 1085 |
| Stretch (%) | 440 |
| Tearing strength (kN/m) | 5.1 |
| Flammability | Flame-resistant |
| Shrinkage after 30 days (% by wt) | 3.2 |

### Embodiment 2

According to the method of the general production example for compact formulations and analogously to embodiment 1, the following components A and B are produced, are reacted together after mixing in a further 100 g water to component A and the following properties are measured:

Component A

| | | |
|---|---|---|
| Magnesium oxide | 4.50 | g |
| Aluminium oxide | 2.00 | g |
| Calcium chloride | 1.50 | g |
| Water | 183.12 | g |
| Acrylic acid copolymer | 2.00 | g |
| Water | 100.00 | g |
| PPG 400 | 4.00 | g |
| Triisopropanol amine | 2.00 | g |
| Na-alkylsulphonate | 0.80 | g |
| Methylpolysiloxane | 0.08 | g |
| (Water) | (100.00 | g) |

| | |
|---|---|
| Viscosity at 20° C. (mPas), measured | 2420 |
| before dilution | |
| pH value | 9.8 |

Component B

| | | |
|---|---|---|
| PPET, MM 6000 | 100.00 | g |
| Aromatic mineral oil extract | 142.00 | g |
| Rape-seed oil methyl ester | 120.00 | g |
| 4,4′-MDI | 38.00 | g |

| | |
|---|---|
| Viscosity at 20° C. (mPas) | 660 |
| NCO content (%) | 2.25 |

Component A + B

| | at room temperature |
|---|---|
| Pot life (min) | 21 |
| Shore A hardness | 11-12 |
| Tensile strength (kN/m²) | 1120 |
| Stretch (%) | 315 |
| Tearing strength (kN/m) | 4.29 |
| Flammability | Non-flammable |
| Shrinkage after 30 days (% by wt) | 0.2 |

### Embodiment 3

According to the method of the general production example for compact formulations and analogously to embodiment 1, the following components A and B are produced, are reacted together after mixing in a further 100 g water to component A and the following properties are measured:

Component A

| | | |
|---|---|---|
| Magnesium oxide | 4.50 | g |
| Aluminium oxide | 1.00 | g |
| Calcium chloride | 2.50 | g |
| Water | 182.12 | g |
| Hydroxypropyl cellulose e.g. Methocel ® J 5 MS | 1.50 | g |
| Acrylic acid copolymer | 1.50 | g |
| Water | 100.00 | g |
| PPG 400 | 4.00 | g |
| Triisopropanol amine | 2.00 | g |
| Na-alkylsulphonate | 0.80 | g |
| Methylpolysiloxane | 0.08 | g |
| (Water) | (100.00 | g) |

| | |
|---|---|
| Viscosity at 20° C. (mPas), measured | 2535 |
| before dilution | |
| pH value | 9.6 |

Component B

| | | |
|---|---|---|
| PPET, MM 6000 | 100.00 | g |
| Aromatic mineral oil extract | 146.00 | g |
| Rape-seed oil methyl ester | 100.00 | g |
| Diisooctyl phthalate | 20.00 | g |
| 4,4′-MDI | 34.00 | g |

| | |
|---|---|
| Viscosity at 20° C. (mPas) | 860 |
| NCO content (%) | 2.10 |

Component A + B

| | at room temperature |
|---|---|
| Pot life (min) | 29 |
| Shore A hardness | 13-15 |
| Tensile strength (kN/m²) | 1210 |
| Stretch (%) | 290 |
| Tearing strength (kN/m) | 4.90 |
| Flammability | non-flammable |
| Shrinkage after 30 days (% by wt) | 0.2 |

### Embodiment 4

According to the method of the general production example for compact formulations and analogously to embodiment 1, the following components A and B are produced, are reacted together after mixing in a further 100 g water to component A and the following properties are measured:

Component A

| | | |
|---|---|---|
| Magnesium oxide | 2.00 | g |
| Aluminium hydroxide | 1.00 | g |
| Calcium chloride | 1.00 | g |
| Water | 185.12 | g |
| Hydroxypropyl cellulose | 1.50 | g |
| Acrylic acid copolymer | 1.50 | g |
| Water | 100.00 | g |
| PPG 400 | 4.00 | g |
| Triisopropanol amine | 2.00 | g |
| Silicone resin emulsion Tegosivin ® HE 829 | 0.80 | g |
| Na-alkylsulphonate | 1.00 | g |
| Methylpolysiloxane | 0.08 | g |
| (Water) | (100.00 | g) |

| | |
|---|---|
| Viscosity at 20° C. (mPas), measured | 2400 |
| before dilution | |
| pH value | 9.6 |

Component B

| | | |
|---|---|---|
| PPET, MM 6000 | 100.00 | g |
| Aromatic mineral oil extract | 146.00 | g |
| Rape-seed oil methyl ester | 100.00 | g |
| Diisooctyl phthalate | 20.00 | g |
| 4,4′-MDI, e.g. Lupranat ® MM 103 | 34.00 | g |

| | |
|---|---|
| Viscosity at 20° C. (mPas) | 900 |
| NCO content (%) | 2.10 |

Component A + B

| | at room temperature |
|---|---|
| Pot life (min) | 32 |
| Shore A hardness | 15-17 |
| Tensile strength (kN/m²) | 1210 |
| Stretch (%) | 290 |
| Tearing strength (kN/m) | 4.20 |
| Flammability | non-flammable |
| Shrinkage after 30 days (% by wt) | 0.15 |

### Embodiment 5

According to the method of the general production example for compact formulations and analogously to embodiment 1, the following components A and B are produced, are reacted together after mixing in a further 100 g water to component A and the following properties are measured:

Component A

| | | |
|---|---|---|
| Magnesium oxide | 2.00 | g |
| Aluminium hydroxide | 1.00 | g |
| Diphenyl urea | 0.70 | g |
| Water | 184.62 | g |
| Hydroxypropyl cellulose | 1.50 | g |
| Acrylic acid copolymer | 1.50 | g |
| Water | 100.00 | g |
| PPG 400 | 4.00 | g |
| Triisopropanol amine | 2.00 | g |
| Silicone resin emulsion Tegosivin ® HE 8999 | 1.60 | g |
| Na-alkylsulphonate | 1.00 | g |
| Methylpolysiloxane | 0.08 | g |
| (Water) | (100.00 | g) |

| | |
|---|---|
| Viscosity at 20° C. (mPas), measured | 2230 |
| before dilution | |
| pH value | 9.1 |

Component B

| | | |
|---|---|---|
| PPET, MM 6000 | 100.00 | g |
| Aromatic mineral oil extract | 146.00 | g |
| Rape-seed oil methyl ester | 100.00 | g |
| Diisooctyl phthalate | 20.00 | g |
| 4,4′-MDI | 34.00 | g |

| | |
|---|---|
| Viscosity at 20° C. (mPas) | 890 |
| NCO content (%) | 2.7 |

Component A + B

| | at room temperature |
|---|---|
| Pot life (min) | 26 |
| Shore A hardness | 13-15 |
| Tensile strength (kN/m²) | 1100 |
| Stretch (%) | 300 |
| Tearing strength (kN/m) | 4.1 |
| Flammability | non-flammable |
| Shrinkage after 30 days (% by wt) | 0.12 |

### Embodiment 6

According to the method of the general production example for compact formulations and analogously to embodiment 1, the following components A and B are produced, are reacted together after mixing in a further 100 g pit water to component A and the following properties are measured:

Component A

| | | |
|---|---|---|
| Magnesium oxide | 2.50 | g |
| Aluminium hydroxide | 2.00 | g |
| Barium hydroxide octahydrate | 3.50 | g |
| Water | 183.12 | g |
| Hydroxypropyl cellulose | 2.00 | g |
| Pit water, pH 3.1 | 100.00 | g |
| PPG 400 | 4.00 | g |
| Triisopropanol amine | 2.00 | g |
| Na-alkylsulphonate | 0.80 | g |
| Methylpolysiloxane | 0.08 | g |
| (Pit water, pH 3.1) | (100.00 | g) |

| | |
|---|---|
| Viscosity at 20° C. (mPas), | 2420 |
| measured before dilution | |
| pH value | 9.8 |

Component B

| | | |
|---|---|---|
| PPET, MM 6000 | 100.00 | g |
| Aromatic mineral oil extract | 142.00 | g |
| Rape-seed oil methyl ester | 120.00 | g |
| 4,4′-MDI | 38.00 | g |

| | |
|---|---|
| Viscosity at 20° C. (mPas) | 850 |
| NCO content (%) | 2.25 |

Component A + B

| | at room temperature |
|---|---|
| Pot life (min) | 33 |
| Shore A hardness | 12-14 |
| Tensile strength (kN/m²) | 1140 |
| Stretch (%) | 300 |
| Tearing strength (kN/m) | 4.10 |
| Flammability | non-flammable |
| Shrinkage after 30 days (% by wt) | 0.3 |

### Embodiment 7

According to the method of the general production example for compact formulations and analogously to embodiment 1, the following components A and B are produced, are reacted together after mixing in a further 100 g water to component A and the following properties are measured:

Component A

| | | |
|---|---|---|
| Magnesium oxide | 4.50 | g |
| Aluminium hydroxide | 2.00 | g |
| Barium hydroxide octahydrate | 1.50 | g |
| Water | 183.12 | g |
| Hydroxypropyl cellulose | 2.00 | g |
| Water | 100.00 | g |
| PPG 400 | 4.00 | g |
| Triisopropanol amine | 2.00 | g |
| Na-alkylsulphonate | 0.80 | g |
| Methylpolysiloxane | 0.08 | g |
| (Water) | (100.00 | g) |

| | |
|---|---|
| Viscosity at 20° C. (mPas), | 2220 |
| measured before dilution | |
| pH value | 9.8 |

Component B

| | | |
|---|---|---|
| PPET, MM 6000 | 100.00 | g |
| Rape-seed oil methyl ester | 262.00 | g |
| 4,4′-MDI | 38.00 | g |

| | |
|---|---|
| Viscosity at 20° C. (mPas) | 590 |
| NCO content (%) | 2.25 |

Component A + B

| | at room temperature |
|---|---|
| Pot life (min) | 31 |
| Shore A hardness | 5-7 |
| Tensile strength (kN/m²) | 990 |
| Stretch (%) | 490 |
| Tearing strength (kN/m) | 2.9 |
| Flammability | non-flammable |
| Shrinkage after 30 days (% by wt) | 0.2 |

### Embodiment 8

According to the method of the general production example for compact formulations and analogously to embodiment 1, the following components A and B are produced, are reacted together after mixing in a further 100 g water to component A and the following properties are measured:

Component A

| | | |
|---|---|---|
| Magnesium oxide | 4.50 | g |
| Aluminium hydroxide | 2.00 | g |
| Barium hydroxide octahydrate | 1.50 | g |
| Water | 183.12 | g |
| Hydroxypropyl cellulose | 2.00 | g |
| Water | 100.00 | g |
| PPG 400 | 4.00 | g |
| Triisopropanol amine | 2.00 | g |
| Na-alkylsulphonate | 0.80 | g |
| Methylpolysiloxane | 0.08 | g |
| (Water) | (100.00 | g) |

| | |
|---|---|
| Viscosity at 20° C. (mPas), | 2400 |
| measured before dilution | |
| pH value | 9.8 |

Component B

| | | |
|---|---|---|
| PPET, MM 6000 | 100.00 | g |
| Rape-seed oil methyl ester | 232.00 | g |
| Aromatic mineral oil extract | 30.00 | g |
| 4,4′-MDI | 38.00 | g |

| | |
|---|---|
| Viscosity at 20° C. (mPas) | 690 |
| NCO content (%) | 2.25 |

Component A + B

| | at room temperature |
|---|---|
| Pot life (min) | 36 |
| Shore A hardness | 7-9 |
| Tensile strength (kN/m²) | 1000 |
| Stretch (%) | 480 |
| Tearing strength (kN/m) | 3.1 |
| Flammability | non-flammable |
| Shrinkage after 30 days (% by wt) | 0.2 |

### Embodiment 9

According to the method of the general production example for compact formulations and analogously to embodiment 1, the following components A and B are produced, are reacted together after mixing in a further 100 g water to component A and the following properties are measured:

Component A

| | | |
|---|---|---|
| Magnesium oxide | 2.50 | g |
| Aluminium hydroxide | 2.00 | g |
| Barium hydroxide octahydrate | 3.50 | g |
| Water | 183.12 | g |
| Hydroxypropyl cellulose | 2.00 | g |
| Water | 100.00 | g |
| PPG 400 | 4.00 | g |
| Triisopropanol amine | 2.00 | g |
| Na-alkylsulphonate | 0.80 | g |
| Methylpolysiloxane | 0.08 | g |
| (Water) | (100.00 | g) |

| | |
|---|---|
| Viscosity at 20° C. (mPas), | 2310 |
| measured before dilution | |
| pH value | 9.8 |

Component B

| | | |
|---|---|---|
| PPET, MM 6000 | 100.00 | g |
| Aromatic mineral oil extract | 142.00 | g |
| Rape-seed oil methyl ester | 120.00 | g |
| 4,4′-MDI | 38.00 | g |

| | |
|---|---|
| Viscosity at 20° C. (mPas) | 850 |
| NCO content (%) | 2.25 |

Component A + B

| | at room temperature |
|---|---|
| Pot life (min) | 33 |
| Shore A hardness | 10-12 |
| Tensile strength (kN/m²) | 1140 |
| Stretch (%) | 300 |
| Tearing strength (kN/m) | 4.10 |
| Flammability | non-flammable |
| Shrinkage after 30 days (% by wt) | 0.3 |

### Embodiment 10

According to the method of the general production example for compact formulations and analogously to embodiment 1, the following components A and B are produced, are reacted together after mixing in a further 100 g water to component A and mixing in a further 50% of the total plasticiser mixture to component B and the following properties are measured:

Component A

| | | |
|---|---|---|
| Magnesium oxide | 4.50 | g |
| Aluminium hydroxide | 1.50 | g |
| Calcium chloride | 2.00 | g |
| Water | 180.62 | g |
| Hydroxypropyl cellulose | 1.50 | g |
| Acrylic acid copolymer | 1.50 | g |
| Water | 100.00 | g |
| PPG 400 | 4.00 | g |
| Triisopropanol amine | 2.00 | g |
| Silicone resin emulsion | 1.50 | g |
| Tegosivin ® HL 1000 | | |
| Na-alkylsulphonate | 0.80 | g |
| Methylpolysiloxane | 0.08 | g |
| (Water) | (100.00 | g) |

| | |
|---|---|
| Viscosity at 20° C. (mPas), | 2535 |
| measured before dilution | |
| pH value | 9.0 |

Component B

| | | |
|---|---|---|
| PPET, MM 6000 | 100.00 | g |
| Aromatic mineral oil extract | 73.00 | g |
| Rape-seed oil methyl ester | 50.00 | g |
| Diisooctyl phthalate | 10.00 | g |
| 4,4′-MDI | 34.00 | g |
| (Plasticiser mixture analogous to above | (133.00 | g) |
| composition) | | |

| | |
|---|---|
| Viscosity at 20° C. (mPas), | 1110 |
| measured before dilution | |
| NCO content, after dilution (%) | 2.6 |

Component A + B

| | at room temperature |
|---|---|
| Pot life (min) | 25 |
| Shore A hardness | 14-16 |
| Tensile strength (kN/m²) | 1130 |
| Stretch (%) | 260 |
| Tearing strength (kN/m) | 3.90 |
| Flammability | non-flammable |
| Shrinkage after 30 days (% by wt) | 0.15 |

### Embodiment 11

According to the method of the general production example for compact formulations and analogously to embodiment 1, the following components A and B are produced, are reacted together after mixing in a further 100 g water to component A and mixing in a further 50% of the total plasticiser mixture to component B and the following properties are measured:

Component A

| | | |
|---|---|---|
| Magnesium oxide | 4.50 | g |
| Aluminium hydroxide | 1.50 | g |
| Calcium chloride | 1.00 | g |
| Urea | 1.00 | g |
| Water | 180.62 | g |
| Hydroxypropyl cellulose | 1.50 | g |
| Acrylic acid copolymer | 1.50 | g |
| Water | 100.00 | g |
| PPG 400 | 4.00 | g |
| Triisopropanol amine | 2.00 | g |
| Silicone resin emulsion | 1.50 | g |
| Tegosivin ® HL 1000 | | |
| Na-alkylsulphonate | 0.80 | g |
| Methylpolysiloxane | 0.08 | g |
| (Water) | (100.00 | g) |

| | |
|---|---|
| Viscosity at 20° C. (mPas), | 2490 |
| measured before dilution | |
| pH value | 9.4 |

Component B

| | | |
|---|---|---|
| PPET, MM 6000 | 100.00 | g |
| Aromatic mineral oil extract | 73.00 | g |
| Ricinus oil methyl ester | 50.00 | g |
| Adipic dinonyl ester | 10.00 | g |
| 4,4′-MDI | 34.00 | g |
| (Plasticiser mixture analogous to above | (133.00 | g) |
| composition) | | |

| | |
|---|---|
| Viscosity at 20° C. (mPas), | 1050 |
| measured before dilution | |
| NCO content, after dilution (%) | 2.50 |

Component A + B

| | at room temperature |
|---|---|
| Pot life (min) | 32 |
| Shore A hardness | 11-13 |
| Tensile strength (kN/m²) | 1180 |
| Stretch (%) | 270 |
| Tearing strength (kN/m) | 4.00 |
| Flammability | non-flammable |
| Shrinkage after 30 days (% by wt) | 0.2 |

### Embodiment 12

According to the method of the general production example for compact formulations and analogously to embodiment 1, the following components A and B are produced, are reacted together after mixing in a further 100 g water to component A and mixing in a further 50% of the total plasticiser mixture to component B and the following properties are measured:

Component A

| | | |
|---|---|---|
| Magnesium oxide | 4.50 | g |
| Aluminium hydroxide | 1.50 | g |
| Calcium chloride | 1.00 | g |
| Urea | 1.00 | g |
| Water | 181.62 | g |
| Hydroxypropyl cellulose | 1.50 | g |
| Calcium sulphoaluminate Cevamit ® | 2.00 | g |
| Water | 100.00 | g |
| PPG 400 | 4.00 | g |
| Triisopropanol amine | 2.00 | g |
| Na-alkylsulphonate | 0.80 | g |
| Methylpolysiloxane | 0.08 | g |
| (Water) | (100.00 | g) |

| | |
|---|---|
| Viscosity at 20° C. (mPas), | 2600 |
| measured before dilution | |
| pH value | 9.4 |

Component B

| | | |
|---|---|---|
| PPET, MM 6000 | 100.00 | g |
| Aromatic mineral oil extract | 73.00 | g |
| Ricinus oil methyl ester | 50.00 | g |
| Palm oil methyl ester | 10.00 | g |
| 4,4′-MDI | 34.00 | g |
| (Plasticiser mixture analogous to above | (133.00 | g) |
| composition) | | |

| | |
|---|---|
| Viscosity at 20° C. (mPas), | 1030 |
| measured before dilution | |
| NCO content, after dilution (%) | 2.40 |

Component A + B

| | at room temperature |
|---|---|
| Pot life (min) | 30 |
| Shore A hardness | 15-18 |
| Tensile strength (kN/m²) | 1300 |
| Stretch (%) | 250 |
| Tearing strength (kN/m) | 4.20 |
| Flammability | non-flammable |
| Shrinkage after 30 days (% by wt) | 0.01 |

### General Production Example for Cellular Formulations

Components A and B are produced corresponding to the general production example for compact formulations. The polyurethane reaction is effected by mixing together components A and B in the volume or weight ratio 1:1 at room temperature and approx. atmospheric pressure, the mixture being expanded and cured within 5 to 15 minutes to form a cellular structure.

### Embodiment 13

According to the method of the general production example for cellular formulations, the following components A and B are produced, are reacted together after mixing in a further 100 g water to component A in the present weight ratio (1:1) and the following properties are measured:

Component A

| | | |
|---|---|---|
| Magnesium oxide | 2.00 | g |
| Calcium hydroxide | 2.00 | g |
| Aluminium hydroxide | 1.00 | g |
| Barium hydroxide octahydrate | 3.00 | g |
| Water | 182.70 | g |
| Hydroxypropyl cellulose | 1.50 | g |
| Water | 100.00 | g |
| PPG 400 | 4.00 | g |
| PPG-diamine, MM 400 | 2.00 | g |
| Foam stabiliser Tegostab ® B 4113 | 0.50 | g |
| Na-alkylsulphonate | 0.80 | g |
| (Water) | (100.00 | g) |

| | |
|---|---|
| Viscosity at 20° C. (mPas), | 2200 |
| measured before dilution | |
| pH value | 10.1 |

Component B

| | | |
|---|---|---|
| PPET, MM 6000 | 80.00 | g |
| PPET, MM 3500 | 20.00 | g |
| Aromatic mineral oil extract | 136.00 | g |
| Rape-seed oil methyl ester | 120.00 | g |
| 4,4′-MDI | 34.00 | g |
| Napthylene diisocyanate | 10.00 | g |

| | |
|---|---|
| Viscosity at 20° C. (mPas) | 870 |
| NCO content (%) | 3.0 |

Component A + B

| | at room temperature |
|---|---|
| Tack-free time (min) | 12 |
| Volumetric density (g/cm³) | 0.19 |
| Compressive strength 40% (kPa) | 4.1 |
| Tensile strength (kPa) | 120 |
| Stretch (%) | 110 |
| Flammability | flame-resistant |
| Shrinkage after 30 days (% by wt) | 0.2 |

### Embodiment 14

According to the method of the general production example for cellular formulations and analogously to embodiment 13, the following components are produced, are reacted together in the present weight ratio (1:0.8) and the following properties are measured:

Component A

| | | |
|---|---|---|
| Magnesium oxide | 2.00 | g |
| Aluminium hydroxide | 1.00 | g |
| Barium hydroxide octahydrate | 5.00 | g |
| Water | 187.20 | g |
| Hydroxypropyl cellulose | 1.50 | g |
| Acrylic acid copolymer | 1.50 | g |
| Water | 92.00 | g |
| PPG 400 | 4.00 | g |
| Silicone resin emulsion Tego ® Phobe 1200 | 1.50 | g |
| Diethylenetriamine | 1.00 | g |
| PPG-diamine, MM 400 | 2.00 | g |
| Foam stabiliser Tegostab ® B 4113 | 0.50 | g |
| Na-alkylsulphonate | 0.80 | g |
| (Water) | (100.00 | g) |

| | |
|---|---|
| Viscosity at 20° C. (mPas), | 2480 |
| measured before dilution | |
| pH value | 11.0 |

Component B

| | | |
|---|---|---|
| PPET, MM 6000 | 64.00 | g |
| PPET, MM 3500 | 16.00 | g |
| Aromatic mineral oil extract | 105.00 | g |
| Rape-seed oil methyl ester | 80.00 | g |
| Diisooctyl phthalate | 16.00 | g |
| 4,4′-MDI | 30.40 | g |
| Napthylene diisocyanate | 8.00 | g |

| | |
|---|---|
| Viscosity at 20° C. (mPas) | 830 |
| NCO content (%) | 3.1 |

Component A + B

| | at room temperature |
|---|---|
| Tack-free time (min) | 6 |
| Volumetric density (g/cm³) | 0.14 |
| Compressive strength 40% (kPa) | 3.8 |
| Tensile strength (kPa) | 140 |
| Stretch (%) | 120 |
| Flammability | non-flammable |
| Shrinkage after 30 days (% by wt) | 0.15 |

### Embodiment 15

According to the method of the general production example for cellular formulations and analogously to embodiment 13, the following components are produced, are reacted together in the present weight ratio (1:0.4) and the following properties are measured:

Component A

| | | |
|---|---|---|
| Magnesium oxide | 2.00 | g |
| Aluminium hydroxide | 1.00 | g |
| Barium hydroxide octahydrate | 5.00 | g |
| Water | 189.20 | g |
| Hydroxypropyl cellulose | 2.00 | g |
| Water | 92.00 | g |
| PPG 400 | 4.00 | g |
| Diethylenetriamine | 1.00 | g |
| PPG-diamine, MM 200 | 2.00 | g |
| Silicone resin emulsion Tego ® Phobe 1401 | 1.00 | g |
| Na-alkylsulphonate | 0.80 | g |
| (Water) | (100.00 | g) |

| | |
|---|---|
| Viscosity at 20° C. (mPas), | 2400 |
| measured before dilution | |
| pH value | 11.0 |

Component B

| | | |
|---|---|---|
| PPET, MM 6000 | 30.80 | g |
| PPET, MM 3500 | 8.00 | g |
| Aromatic mineral oil extract | 49.20 | g |
| Rape-seed oil methyl ester | 40.00 | g |
| Palm oil methyl ester | 8.00 | g |
| 4,4′-MDI | 16.00 | g |
| Isophorone diisocyanate | 8.00 | g |

| | |
|---|---|
| Viscosity at 20° C. (mPas) | 850 |
| NCO content (%) | 4.9 |

Component A + B

| | at room temperature |
|---|---|
| Tack-free time (min) | 4 |
| Volumetric density (g/cm³) | 0.13 |
| Compressive strength 40% (kPa) | 4.5 |
| Tensile strength (kPa) | 110 |
| Stretch (%) | 140 |
| Flammability | non-flammable |
| Shrinkage after 30 days (% by wt) | 0.05 |

### Embodiment 16

According to the method of the general production example for cellular formulations and analogously to embodiment 13, the following components are produced, are reacted together in the weight or volume ratio 1:1 and the following properties are measured:

Component A

| | | |
|---|---|---|
| Magnesium oxide | 2.00 | g |
| Aluminium hydroxide | 1.50 | g |
| Barium hydroxide octahydrate | 5.00 | g |
| Water | 188.20 | g |
| Acrylic acid copolymer | 1.50 | g |
| Water | 92.00 | g |
| PPG 400 | 4.00 | g |
| Triethylamine | 1.00 | g |
| PPG-diamine, MM 400 | 2.00 | g |
| Alkylsilane Protectosil ® 100 N | 2.00 | g |
| Na-alkylsulphonate | 0.80 | g |
| (Water) | (100.00 | g) |

| | |
|---|---|
| Viscosity at 20° C. (mPas), | 2390 |
| measured before dilution | |
| pH value | 11.0 |

Component B

| | | |
|---|---|---|
| PPET, MM 6000 | 80.00 | g |
| PPET, MM 3500 | 20.00 | g |
| Aromatic mineral oil extract | 136.00 | g |
| Rape-seed oil methyl ester | 100.00 | g |
| Diisooctyl phthalate | 20.00 | g |
| 4,4′-MDI | 34.00 | g |
| Napthylene diisocyanate | 10.00 | g |

| | |
|---|---|
| Viscosity at 20° C. (mPas) | 840 |
| NCO content (%) | 3.4 |

Component A + B

| | at room temperature |
|---|---|
| Tack-free time (min) | 4 |
| Volumetric density (g/cm³) | 0.09 |
| Compressive strength 40% (kPa) | 4.2 |
| Tensile strength (kPa) | 130 |
| Stretch (%) | 110 |
| Flammability | non-flammable |
| Shrinkage after 30 days (% by wt) | 0.05 |

### Embodiment 17

According to the method of the general production example for cellular formulations and analogously to embodiment 13, the following components A and B are produced, are reacted together after mixing in a further 100 g water to component A and mixing in a further 50% of the total plasticiser mixture to component B in the present weight ratio 1:1) and the following properties are measured:

Component A

| | | |
|---|---|---|
| Magnesium oxide | 2.00 | g |
| Aluminium hydroxide | 1.50 | g |
| Barium hydroxide octahydrate | 5.00 | g |
| Water | 189.20 | g |
| Acrylic acid copolymer | 1.50 | g |
| Water | 92.00 | g |
| PPG 400 | 4.00 | g |
| Triethylamine | 1.00 | g |
| PPG-diamine, MM 400 | 2.00 | g |
| Alkylsilane Protectosil ® 40 S | 1.00 | g |
| Na-alkylsulphonate | 0.80 | g |
| (Water) | (100.00 | g) |

| | |
|---|---|
| Viscosity at 20° C. (mPas), | 2430 |
| measured before dilution | |
| pH value | 11.0 |

Component B

| | | |
|---|---|---|
| PPET, MM 6000 | 80.00 | g |
| PPET, MM 3500 | 20.00 | g |
| Aromatic mineral oil extract | 68.00 | g |
| Rape-seed oil methyl ester | 50.00 | g |
| Diisooctyl phthalate | 10.00 | g |
| 4,4′-MDI | 34.00 | g |
| Toluylene diisocyanate (TDI 80/20) | 10.00 | g |
| (Plasticiser mixture analogous to above | (128.00 | g) |
| composition) | | |

| | |
|---|---|
| Viscosity at 20° C. (mPas), | 1230 |
| measured before dilution | |
| NCO content, after dilution (%) | 3.2 |

Component A + B

| | at room temperature |
|---|---|
| Tack-free time (min) | 7 |
| Volumetric density (g/cm³) | 0.10 |
| Compressive strength 40% (kPa) | 3.9 |
| Tensile strength (kPa) | 130 |
| Stretch (%) | 100 |
| Flammability | non-flammable |
| Shrinkage after 30 days (% by wt) | 0.05 |

### Embodiment 18

According to the method of the general production example for cellular formulations and analogously to embodiment 13, the following components A and B are produced, are reacted together after mixing in a further 100 g water to component A and mixing in a further 50% of the total plasticiser mixture to component B in the present weight ratio 1:1) and the following properties are measured:

Component A

| | | |
|---|---|---|
| Aluminium hydroxide | 1.50 | g |
| Barium hydroxide octahydrate | 7.00 | g |
| Water | 190.50 | g |
| Acrylic acid copolymer | 1.50 | g |
| Water | 92.00 | g |
| PPG 400 | 4.00 | g |
| Triethylamine | 1.00 | g |
| PPG-diamine, MM 3000 | 0.70 | g |
| Alkylsilane Protectosil ® 40 S | 1.00 | g |
| Na-alkylsulphonate | 0.80 | g |
| (Water) | (100.00 | g) |

| | |
|---|---|
| Viscosity at 20° C. (mPas), | 2390 |
| measured before dilution | |
| pH value | 12.0 |

Component B

| | | |
|---|---|---|
| PPET, MM 6000 | 80.00 | g |
| PPET, MM 3500 | 20.00 | g |
| Diethylhexyl phthalate | 68.00 | g |
| Palm oil methyl ester | 60.00 | g |
| 4,4′-MDI | 34.00 | g |
| Hexamethylene diisocyanate-1,6 | 10.00 | g |
| (Plasticiser mixture analogous to above | (128.00 | g) |
| composition) | | |

| | |
|---|---|
| Viscosity at 20° C. (mPas), | 1250 |
| measured before dilution | |
| NCO content, after dilution (%) | 3.0 |

Component A + B

| | at room temperature |
|---|---|
| Tack-free time (min) | 4 |
| Volumetric density (g/cm³) | 0.06 |
| Compressive strength 40% (kPa) | 3.5 |
| Tensile strength (kPa) | 110 |
| Stretch (%) | 140 |
| Flammability | non-flammable |
| Shrinkage after 30 days (% by wt) | 0.05 |

### Embodiment 19

For the production of compact moulded articles which are intended to be subjected to a direct water effect, the compact polyurethane materials with a high water content according to embodiments 1 to 12 are coated or covered after a curing time of 4 to 9 hours in a suitable mould corresponding to the application purpose with a newly produced and not yet cured, conventional, water-free polyurethane elastomer which was produced according to a stoichiometric polyaddition method, such as e.g. the subsequently cited composition:

200 g polyurethane elastomer, e.g. according to the embodiment 1+
200 g polyurethane elastomer, produced from
100 g component A and 100 g component B comprising:

| Component A | | Component B | |
|---|---|---|---|
| Aromatic mineral oil | 23.90 g | Aromatic mineral oil | 35.50 g |
| extract | | extract | |
| Palm oil methyl | 23.90 g | Palm oil methyl ester | 40.50 g |
| ester | | | |
| Polyether triol | 49.00 g | Polyether triol | 11.00 g |
| MM 6000 | | MM 6000 | |
| Polypropylene glycol | 2.00 g | | |
| MM 400 | | | |
| Dicyclohexylamine | 0.9 g | Silicone defoamer | 0.01 g |
| Water | 0.3 g | 4,4′-diphenylmethane | 13.00 g |
| | | diisocyanate | |

### Embodiment 20

For the production of combined cellular-compact moulded articles for various application purposes, the cellular compact polyurethane materials with a high water content are coated or covered according to embodiments 13 to 18 after a curing time of 1 to 2 hours in a suitable mould corresponding to the application purpose with a newly produced and not yet cured, conventional, water-free polyurethane elastomer, e.g. according to embodiment 11:

200 g cellular polyurethane, e.g. according to embodiment 15+
200 g water-free compact polyurethane elastomer according to embodiment 20.

### Embodiment 21

100 g component A and 100 g component B, e.g. according to embodiment 2, are mixed together intimately, thereafter agitated with 40 g quartz powder to form a homogeneous mass and left to cure at room temperature. The end product has the following properties:

| | |
|---|---|
| Shore A hardness | 25-27 |
| Tensile strength (kN/m²) | 1270 |
| Stretch (%) | 210 |
| Tearing strength (kN/m) | 6.2 |
| Flammability | non-flammable |
| Shrinkage after 30 days (% by wt) | 0.10 |

1. Compact or cellular polyurethane with a high water content, obtainable by reaction of a component A and a component B, optionally in the presence of an expanding agent,
component A comprising water in a proportion of at least 50% by weight, an organic swelling agent, an agent for preventing shrinkage and optionally further organic or inorganic additives, and
component B comprising one or more polyhydroxy compounds, one or more polyisocyanates and/or the reaction product thereof, optionally a plasticiser and further organic or inorganic additives.

2. Cellular polyurethane with a high water content, obtainable by reaction of a component A and a component B, optionally in the presence of an expanding agent,
component A comprising water in a proportion of at least 50% by weight, an organic swelling agent, optionally an agent for preventing shrinkage and optionally further organic or inorganic additives, and
component B comprising one or more polyhydroxy compounds, one or more polyisocyanates and/or the reaction product thereof, optionally a plasticiser and further organic or inorganic additives.

3. Compact or cellular polyurethane with a high water content, obtainable by reaction of a component A and a component B, optionally in the presence of an expanding agent,
component A comprising water in a proportion of at least 50% by weight, an organic swelling agent, selected from polymers on an acrylic basis, optionally an agent for preventing shrinkage and optionally further organic or inorganic additives, and
component B comprising one or more polyhydroxy compounds, one or more polyisocyanates and/or the reaction product thereof, optionally a plasticiser and further organic or inorganic additives.

4. Compact or cellular polyurethane with a high water content, obtainable by reaction of a component A and a component B, optionally in the presence of an expanding agent,
component A comprising water in a proportion of at least 50% by weight, an organic swelling agent, optionally an agent for preventing shrinkage and optionally further organic or inorganic additives, and
component B comprising one or more polyhydroxy compounds, one or more polyisocyanates, a plasticiser and further organic or inorganic additives, the plasticiser predominantly comprising products based on renewable raw materials.

5. Polyurethane according to claim 1, wherein the plasticisers are selected at least partially from natural oils, in particular vegetable oils and the esterification products thereof.

6. Polyurethane according to claim 1, wherein it comprises a proportion of non-reacted water of 25 to 49% by weight, based on the total mass.

7. Polyurethane according to claim 1, wherein it has a weight- or/and volume constancy of ≦5% by weight or ≦5% by volume, based on the total mass, after 30 days at room temperature and normal pressure.

8. Polyurethane according to claim 1, characterised in that it has a volumetric density of 0.03 to 0.3 g/cm³.

9. Polyurethane according to one of the claim 1, wherein it is flame-resistant or non-flammable, determined by a laboratory method with a seven-minute direct flame treatment at 700 to 750° C.

10. Polyurethane composite material, containing a polyurethane with a high water content, in particular according to claim 1, in a composite with an essentially water-free polyurethane.

11. Method for the production of a polyurethane according to claim 1, comprising the reaction of a component A and a component B, optionally in the presence of an expanding agent,
component A comprising water is a proportion of at least 50% by weight, an organic swelling agent, optionally an agent for preventing shrinkage and optionally further organic or inorganic additives, and
component B comprising one or more polyhydroxy compounds, one or more polyisocyanates and/or the reaction product thereof, optionally a plasticiser and further organic or inorganic additives,
component A being produced optionally via the intermediate step of a concentrate with a reduced water proportion, component B being produced optionally via the intermediate step of a concentrate with a reduced plasticiser proportion, both components being reacted optionally in the presence of an expanding agent and the resulting end product with a high water content being converted into a composite material, optionally in addition with substantially water-free polyurethane.

12. Concentrate of a component A for the production of a compact or cellular polyurethane with a high water content, in particular according to claim 1, comprising water in a proportion of at least 25 to 50% by weight, an organic swelling agent, an agent for preventing shrinkage and optionally further organic or inorganic additives.

13. Concentrate of a component B for the production of a compact or cellular polyurethane with a high water content, in particular according to claim 1, comprising one or more polyhydroxy compounds, one or more polyisocyanates and/or the reaction product thereof, a plasticiser in up to 50% of the total quantity for the production of the polyurethane and optionally further organic or inorganic additives.
